(19) United States
(12) Patent Application Publication
(10) Pub. No.: US 2004/0105246 A1
(43) Pub. Date: Jun. 3, 2004

(54) Control element

(76) Inventors: Heiko Glienicke, Salz (DE); Thomas Ofenhitzer, Salz (DE)

Correspondence Address: BIRCH STEWART KOLASCH & BIRCH, PO BOX 747, FALLS CHURCH, VA, 22040-0747, US

(21) Appl. No.: 10/721,358

(22) Filed: Nov. 26, 2003

(30) Foreign Application Priority Data
Nov. 28, 2002 (DE) DE 102 55 48.3-34

(51) Int. Cl. G01D 11/28

(52) U.S. Cl. 362/23

(57) ABSTRACT

It is proposed to divide a preferably stationary optical light guide into two regions by an annular slot into which an operating panel projects. The inner region is to be visible to a user and represents a corona, which has an illuminated night design. The outer region is covered by the panel and illuminates the scale that includes various symbols and surrounds the rotary knob.

This nonprovisional application claims priority under 35 U.S.C. § 119(a) on Patent Application No. 102 55 480.3-34 filed in Germany on Nov. 28, 2002, which is herein incorporated by reference.

### BACKGROUND OF THE INVENTION

1. Field of the Invention

The present invention relates to an illuminated control element.

2. Description of the Background Art

As is well known, control elements have symbols at the top, which especially in motor vehicles must be illuminated, and wherein a distinction is drawn between nighttime illumination and daytime illumination.

From DE 198 34 374 A1 is known a rotary knob of a control unit. For better illumination of a scale, provision is made for an optical light guide to end with its upper circumferential surface in a transparent housing part that has an externally visible scale and an additional optical light guide, fixed with respect to the housing and located between the scale and the circumferential part, that possesses total reflection in its optical path.

DE 195 42 913 C2 discloses an illuminatable control element arrangement, whereby illumination of the rotary knobs and the associated display symbols are desired. This is accomplished by a particular pass-through element that is designed to transmit light, at least in the section passing through a light box between a front panel and a bearing sleeve.

A corona (free space between the scale and the rotary knob) that is present around such control element is, however, not illuminated.

### SUMMARY OF THE INVENTION

It is therefore an object of the present invention to provide an illuminating system having a simple design that also permits illumination of a corona.

The invention is based on the idea of dividing a preferably stationary optical light guide into two regions by an annular slot into which an operating or front panel projects. The inner region is to be visible to a user and represents the corona, which has an illuminated night design. The outer region is covered by the panel and illuminates a scale that has various symbols and surrounds a rotary knob.

The symbols arranged around the rotary knob, which are backlighted (lighting for identification) in the night design, are produced by a laser, injection-molding, or film technique, and are easily recognizable in the daylight design by establishing appropriate contrast with their surroundings. The corona is illuminated as a luminous ring around the rotary knob and is very difficult or impossible to detect in the unlighted state.

The brightness of the scale and corona is regulated by light-scattering components in the optical light guide, appropriate wall thicknesses in the symbol area, and by a light-diverting bevel on the underside of the optical light guide.

The proposed solution permits the simultaneous illumination of a scale and corona using a single device.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a top view of a control element; and

FIG. 2 is a combined scale and corona illumination.

### DETAILED DESCRIPTION OF THE PREFERRED EMBODIMENTS

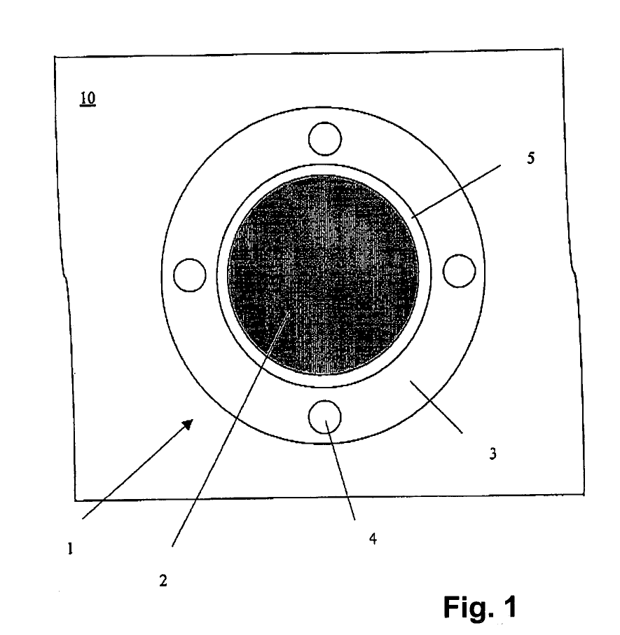

Shown in FIG. 1 is a top view of a control element 1 located in a panel 10 or the like with a rotary knob 2. Arranged about the rotary knob 2 is an annular scale 3 integrated into the panel 10 with symbols 4. Located between the scale 3 and the rotary knob 2 is a corona 5 that is to be illuminated.

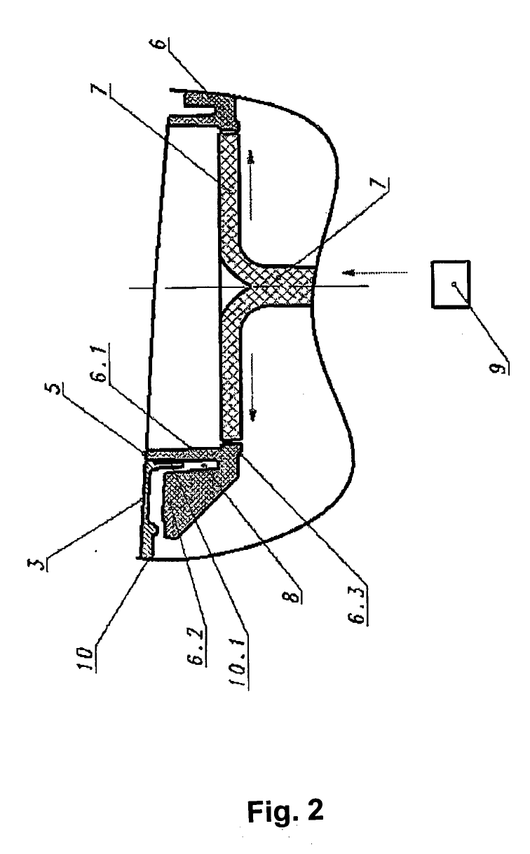

FIG. 2 shows a combined illumination of the scale 3 and the corona 5. This joint illumination is accomplished by means of a preferably nonrotating optical light guide 6 which has two parts, an inner part 6.1 and an outer part 6.2, which are separated by an annular slot 8 in which the parts 10.1 of the panel 10 engage and/or project. The light from a light source 9 located below a light rotor 7 is transported through the light rotor 7 into the upper region, where it is coupled to the optical light guide 6 for backlighting or illumination of the scale 3 and the corona 5.

To improve the light transport to the scale 3 and the corona 5, as well as to produce different brightness levels, provision is made for at least one diverting bevel 6.3 to be built into the outside of the optical light guide 6.

It is a matter of course that refinements are possible within the concept of the invention. Thus, the optical light guide 6 can be adjusted in functional combination with the light rotor 7, wherein a one-piece combination of the light rotor 7 and the optical light guide 6 is then a preferred alternative.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A control element having a combined scale and corona illumination, wherein the scale is a part of a panel that is designed to work together with the control element, the control element comprising:
an optical light guide that includes two parts, which are partially separated by an annular slot, such that parts of the panel can engage or project into the slot;
a light rotor that extends towards the optical light guide to a height necessary for light transport; and
a light source located below the light rotor.

2. The control element according to claim 1, wherein arranged on the scale around the rotary knob of the control element are symbols, which are backlighted in the night design and are easily recognizable in the daylight design by establishing appropriate contrast with their surroundings.

3. The control element according to claim 2, wherein the symbols are produced by a laser, injection-molding, or film technique.

4. The control element according to claim 1, wherein the corona is illuminated in the night design as a luminous ring around the rotary knob and is not illuminated in the daylight design and thus very difficult or impossible to detect.

5. The control element according to claim 1, wherein the brightness of the scale and corona is regulated by light-scattering components in the optical light guide.

6. The control element according to claim 1, wherein the brightness of the scale and corona is regulated by an appropriate wall thickness in the symbol area.

7. The control element according to claim 1, wherein the brightness of the scale and corona is regulated by at least one light-diverting bevel provided on an underside of the optical light guide on a circumferential side.

8. The control element according to claim 1, wherein the optical light guide is fixed relative to the control element.

9. The control element according to claim 1, wherein the optical light guide can be adjusted in functional combination with the light rotor.

10. The control element according to claim 1, wherein the optical light guide and the light rotor are formed as a single piece.

11. A control element comprising:
a rotary knob;
a corona substantially circumscribing the rotary knob, the corona being adapted to emit light therefrom;
a scale substantially circumscribing the corona and the rotary knob, the scale being adapted to emit light therefrom;
an optical light guide having an annular slot provided therein, the annular slot being formed to receive a projection extending from the scale; the optical light guide directing light towards the scale and the corona; and
a light rotor that directs light from a light source towards the optical light guide.

12. The control element according to claim 11, wherein the scale completely circumscribes the corona and the corona completely circumscribes the rotary knob.

13. The control element according to claim 11, wherein the light rotor directs light towards the optical light guide from an outer perimeter of the light rotor.

14. The control element according to claim 11, wherein the scale includes at least one symbol formed thereon.

15. The control element according to claim 11, wherein a surface of the corona is formed to resemble a surface of the rotary knob and/or the scale such that a user is not able to detect the corona when light is not being emitted by the corona.
